(19) United States
(12) Patent Application Publication
(10) Pub. No.: US 2024/0308922 A1
(43) Pub. Date: Sep. 19, 2024

(54) TOOLING FOR PRODUCING Z-CHANNELS IN CERAMIC FIBER PREFORMS

(71) Applicant: Raytheon Technologies Corporation, Farmington, CT (US)

(72) Inventors: Molly Kole, Hartford, CT (US); Olivier H. Sudre, Glastonbury, CT (US)

(21) Appl. No.: 18/123,046

(22) Filed: Mar. 17, 2023

(51) Int. Cl. C04B 35/80; C04B 35/628; C04B 35/634; D04H 18/02

(52) U.S. Cl. CPC C04B 35/80; C04B 35/62834; C04B 35/62884; C04B 35/634; D04H 18/02; C04B 2235/5224; C04B 2235/5244; C04B 2235/5256; C04B 2235/5276; C04B 2235/614

(57) ABSTRACT

A needle array suitable for perforating a fibrous preform includes a backplate and a plurality of needles individually removably attached to and extending away from the backplate. Each of the plurality of needles includes a bundle of ceramic filaments, a metallic sheath surrounding a first end of the bundle abutting the backplate, and a sharpened point on the second end of the bundle, the second end being oppositely disposed from the first end.

### BACKGROUND

The present invention relates to the fabrication of ceramic matrix composites (CMCs) and, more particularly, to CMCs having improved properties for operating in gas turbine engines.

In the processing of CMCs, there is a need to infiltrate matrix within and around fibrous tows to replace pore volume with dense matrix material. In a woven system, large voids often exist between adjacent tows of a preform. Such voids can become large defects after infiltration of the composite that are detrimental to composite properties. The pore network through a woven system is often highly tortuous for infiltrating reactant vapors, which leads to uneven deposition through the thickness of the preform.

The formation of z-channels can create more direct pathways for reactant gases. However, the metallic needles commonly used to form z-channels can contaminate and/or deform the preform. For example, metallic particles from the needles can remain in the preform after needle removal. Such particles and the preform ceramic material(s) can have dissimilar thermal and mechanical properties, thus their presence in the final CMC can be detrimental. Improved means for perforating preforms are therefore desirable.

### SUMMARY

A needle array suitable for perforating a fibrous preform includes a backplate and a plurality of needles individually removably attached to and extending away from the backplate. Each of the plurality of needles includes a bundle of ceramic filaments, a metallic sheath surrounding a first end of the bundle abutting the backplate, and a sharpened point on the second end of the bundle, the second end being oppositely disposed from the first end.

A method of forming a needle array suitable for perforating a fibrous preform includes arranging a plurality of ceramic filaments in a length-wise manner to form a bundle, coating the bundle with a reinforcing material, wrapping a sheath around the bundle such that the bundle has a sheathed portion at a first end and an exposed portion at a second end, securing the sheath to the bundle using an adhesive material, and forming a needle tip on the second end of the bundle.

A method of forming a needle suitable for perforating a fibrous preform includes arranging a plurality of ceramic filaments in a length-wise manner to form a bundle, coating the bundle with a reinforcing material, wrapping a sheath around the bundle such that the bundle has a sheathed portion at a first end and an exposed portion at a second end, securing the sheath to the bundle using an adhesive material, and forming a needle tip on the second end of the bundle.

### BRIEF DESCRIPTION OF THE DRAWINGS

FIG. 1 is a simplified cross-sectional view of a fibrous ceramic preform.

FIG. 2 is a simplified perspective view of a bundle of ceramic filaments.

FIG. 3 is a simplified plan view of the top of the bundle of FIG. 2.

FIG. 4 is a simplified perspective view of a metallic sheath wrapped around the bundle of FIG. 2.

FIG. 5 is a simplified view of a needle formed after sharpening the end of the sheath-wrapped bundle of FIG. 4.

FIG. 6 is a simplified perspective view of a portion of the bundle with an alternative tip.

FIG. 7 is a simplified side view of an array of needles.

While the above-identified figures set forth one or more embodiments of the present disclosure, other embodiments are also contemplated, as noted in the discussion. In all cases, this disclosure presents the invention by way of representation and not limitation. It should be understood that numerous other modifications and embodiments can be devised by those skilled in the art, which fall within the scope and spirit of the principles of the invention. The figures may not be drawn to scale, and applications and embodiments of the present invention may include features and components not specifically shown in the drawings.

### DETAILED DESCRIPTION

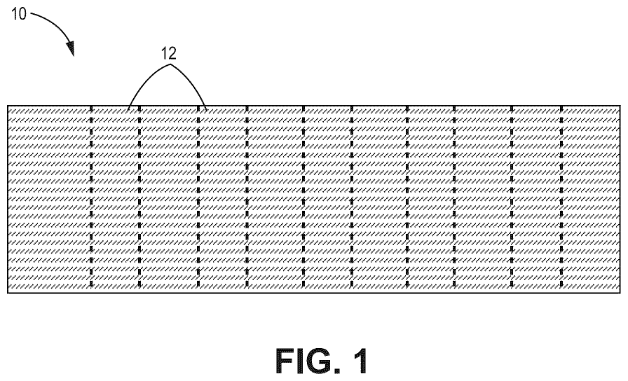

FIG. 1 is a simplified cross-sectional view of preform 10, which can be formed from ceramic (e.g., silicon carbide—SiC) tows arranged in one of various two or three-dimensional woven architectures such as plain, harness (e.g., 3, 5, 8, etc.), twill, braid, tape layup, or non-symmetric to name a few non-limiting examples. Non-woven architectures (e.g., chopped, felted, etc.) are also contemplated herein. A CMC formed from preform 10 can be incorporated into a gas turbine engine. To facilitate more even matrix infiltration during chemical vapor infiltration (CVI), it can be desirable to form z-channels extending through the thickness of preform 10. Z-channels provide a much less tortuous pathway along which reactant CVI gases can traversed preform 10. A desirable pattern for z-channels 12 is represented in dashed lines in FIG. 1. Z-channels 12 can be formed using needles, which are traditionally formed from a metallic material strong enough to penetrate the ceramic perform (e.g., preform 10). The use of such needles often results in metallic contaminants left in the preform. Accordingly, this disclosure presents the making and use of ceramic needles for z-channel formation.

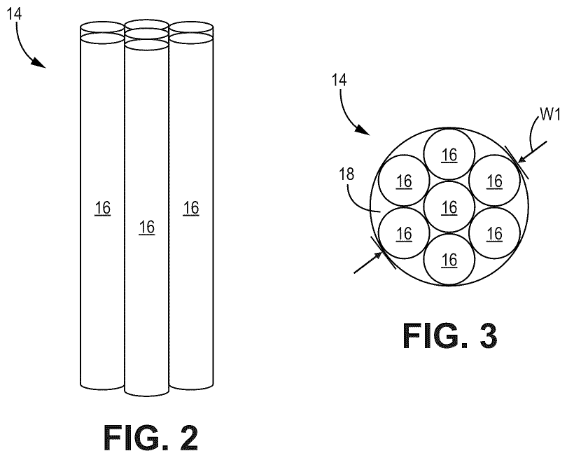

FIG. 2 is a simplified perspective view of bundle 14 of ceramic filaments 16. Filaments 16 can be relatively large-diameter filaments, for example, with filament diameters of at least 25 microns, and in an exemplary embodiment, between 25 microns and 250 microns. Suitable filament types include SCS-6 monofilaments. Alternatively, bundle 14 can be formed from a subset of fibers from a subdivided (e.g., 500-fiber) ceramic tow. Each filament (or fiber) 16 can be formed from a ceramic material, such as silicon carbide (SiC), silicon nitride (Si₃N₄), or aluminum oxide (Al₂O₃). Each filament 16 can further include an interface coating (IFC) of one or a combination of boron nitride (BN), SiC, Si₃N₄, or pyrolytic carbon (PyC), to name a few non-limiting examples, to provide additional toughness to the resulting needle. The ceramic selected can be uniform across a given bundle 14 to ensure homogeneity of its mechanical properties. Filaments 16 can be arranged in a length-wise manner and secured as bundle 14 by, for example, coating bundle 14.

FIG. 3 is a simplified plan view of the top of bundle 14, with filaments 16 encased in reinforcing coating 18. Coating 18 can be a polymer coating, such as an epoxy resin. Alternatively, coating 18 can be a ceramic material deposited using chemical vapor deposition (CVD) or infiltration (CVI), a polymer-derived ceramic material formed by pyrolyzing a preceramic polymer, or a silicon alloy melt. As shown in FIG. 3, bundle 14 further has a width (or diameter) W1.

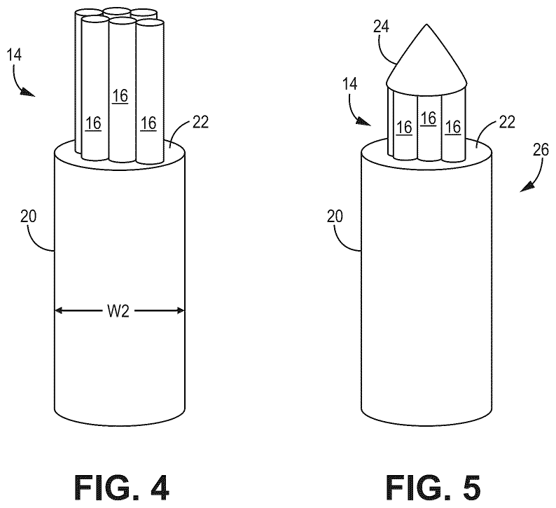

After individual filaments 16 are secured together, bundle 14 can be further reinforced. FIG. 4 is a simplified perspective view of metallic sheath 20 wrapped around a portion/one end of bundle 14. Adhesive material 22 (e.g., glue, cement, or solder) can secure metallic sheath 20 around bundle 14. Metallic sheath 20 has a width (or diameter) W2 which can be greater than width W1 of bundle 14. FIG. 5 is a simplified perspective view showing bundle 14 after its exposed (i.e., unsheathed) end/tip has been sharpened to a point (i.e., point 24). Point 24 can be formed using, for example, a grinding wheel or a jig. Rotation of point 24 evenly relative to the grinding wheel or jig can form the generally conical point 24 shown in FIG. 5. In an alternative embodiment, a point having an off-axis orientation can be formed by preferentially sharpening one portion of point 24. Because it is formed from the underlying ceramic filaments 16, point 24 is also ceramic. With point 24 formed, the entire arrangement of bundle 14 with metallic sheath 20 becomes needle 26. In some embodiments, needle 26 can undergo CVI for additional SiC coating(s).

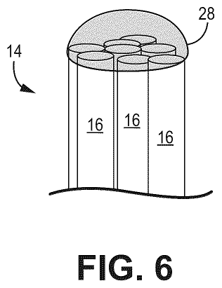

FIG. 6 is a perspective view of just the exposed portion of bundle 14. Instead of forming point 24, a bead can be placed on the end of bundle 14 to form beaded tip 28. Beaded tip 28 has a rounded shape, and can be used, for example, with certain types of fabric (e.g., loosely woven, low PPI/EPI, etc.) to non-destructively push tows away as it moves through preform 10. Beaded tip 28 can be formed from a SiC precursor or polymer material, to name a few non-limiting examples.

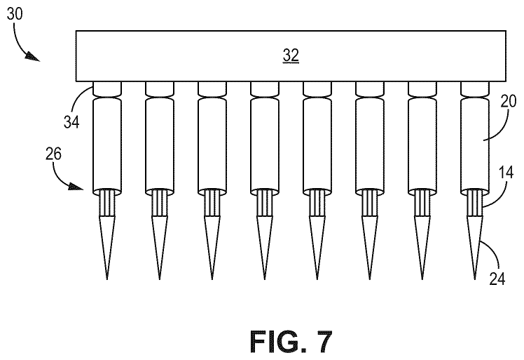

FIG. 7 is a simplified side view of needle array 30 with multiple needles 26 extending from backplate 32. As shown, each needle 26 includes metallic sheath 20 surrounding a bundle 14 of filaments/fibers, and conical point 24. Each needle 26 can be removably connected to backplate 32 via threaded or other engagement with mounts 34. Needles 26 can be arranged in columns and rows, or other pattern, and may correspond to infiltration holes of a tooling fixture (not shown) in order to be used with tooling-mounted fixtures. As such, the maximum width of a particular needle (i.e., W2) should be smaller than the diameter of an infiltration hole.

Needles 26 are individually removable to such that damaged needles 26 can be easily replaced, or the particular arrangement of needles 26 altered as desired. Generally speaking, only the ceramic, unsheathed portion (i.e., portion not covered by metallic sheath 20) of needle 26 will be inserted into a preform (i.e., preform 10) for z-channel formation. Thus, any contaminants (i.e., ceramic particles from needles 26) remaining in preform 10 after z-channel formation can become part of the final CMC component with little detrimental impact on component properties. Needles 26 formed from ceramic may also be more durable than metallic needles, with a longer useful life.

A CMC component formed with the disclosed perforating means can be incorporated into aerospace, maritime, or industrial equipment, to name a few, non-limiting examples.

### Discussion of Possible Embodiments

The following are non-exclusive descriptions of possible embodiments of the present invention.

A needle array suitable for perforating a fibrous preform includes a backplate and a plurality of needles individually removably attached to and extending away from the backplate. Each of the plurality of needles includes a bundle of ceramic filaments, a metallic sheath surrounding a first end of the bundle abutting the backplate, and a sharpened point on the second end of the bundle, the second end being oppositely disposed from the first end.

The needle array of the preceding paragraph can optionally include, additionally and/or alternatively, any one or more of the following features, configurations and/or additional components:

In the above needle array, each of the ceramic filaments can be formed from one of silicon carbide, silicon nitride, and aluminum oxide.

In any of the above needle arrays, each of the ceramic filaments can further include an interface coating of at least one of boron nitride, silicon carbide, silicon nitride, and pyrolytic carbon.

In any of the above needle arrays, the bundle of ceramic filaments can further include a reinforcing coating including one of epoxy, a ceramic, a polymer-derived ceramic, and a silicon alloy.

In any of the above needle arrays, the metallic sheath can be secured to the bundle of ceramic filaments with an adhesive material.

In any of the above needle arrays, a width of the metallic sheath can be greater than a width of the bundle of ceramic filaments.

A method of forming a needle array suitable for perforating a fibrous preform includes arranging a plurality of ceramic filaments in a length-wise manner to form a bundle, coating the bundle with a reinforcing material, wrapping a sheath around the bundle such that the bundle has a sheathed portion at a first end and an exposed portion at a second end, securing the sheath to the bundle using an adhesive material, and forming a needle tip on the second end of the bundle.

The method of the preceding paragraph can optionally include, additionally and/or alternatively, any one or more of the following features, configurations and/or additional components:

In the above method, forming the needle tip can include placing a rounded bead on the second end.

In any of the above methods, the rounded bead can be formed from one of a silicon carbide precursor and a polymer material.

In any of the above methods, forming the needle tip can include sharpening the second end to form a point.

In any of the above methods, the second end can be sharpened using one of a grinding wheel and a jig.

Any of the above methods can further include attaching each of the plurality of needles to a backplate.

A method of forming a needle suitable for perforating a fibrous preform includes arranging a plurality of ceramic filaments in a length-wise manner to form a bundle, coating the bundle with a reinforcing material, wrapping a sheath around the bundle such that the bundle has a sheathed portion at a first end and an exposed portion at a second end, securing the sheath to the bundle using an adhesive material, and forming a needle tip on the second end of the bundle.

The method of the preceding paragraph can optionally include, additionally and/or alternatively, any one or more of the following features, configurations and/or additional components:

In the above method, forming the needle tip can include placing a rounded bead on the second end.

In any of the above methods, the rounded bead can be formed from one of a silicon carbide precursor and a polymer material.

In any of the above methods, forming the needle tip can include sharpening the second end to form a point.

In any of the above methods, the second end can be sharpened using one of a grinding wheel and a jig.

Any of the above methods can further include attaching the needle to a backplate.

In any of the above methods, the reinforcing coating can include one of epoxy, a ceramic, a polymer-derived ceramic, and a silicon alloy.

Any of the above methods can further include after forming the needle, applying silicon carbide to the needle using chemical vapor infiltration.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A needle array suitable for perforating a fibrous preform, the needle array comprising:
a backplate; and
a plurality of needles individually removably attached to and extending away from the backplate, each of the plurality of needles comprising:
a bundle of ceramic filaments;
a metallic sheath surrounding a first end of the bundle abutting the backplate; and
a sharpened point on the second end of the bundle, the second end being oppositely disposed from the first end.

2. The needle array of claim 1, wherein each of the ceramic filaments is formed from one of silicon carbide, silicon nitride, and aluminum oxide.

3. The needle array of claim 2, wherein each of the ceramic filaments further comprises an interface coating of at least one of boron nitride, silicon carbide, silicon nitride, and pyrolytic carbon.

4. The needle array of claim 2, wherein the bundle of ceramic filaments further comprises a reinforcing coating of one of epoxy, a ceramic, a polymer-derived ceramic, and a silicon alloy.

5. The needle array of claim 1, wherein the metallic sheath is secured to the bundle of ceramic filaments with an adhesive material.

6. The needle array of claim 1, wherein a width of metallic sheath is greater than a width of the bundle of ceramic filaments.

7. A method of forming a needle array suitable for perforating a fibrous preform, the method comprising:
forming a plurality of needles, wherein forming each of the plurality of needles comprises:
arranging a plurality of ceramic filaments in a length-wise manner to form a bundle;
coating the bundle with a reinforcing material;
wrapping a sheath around the bundle such that the bundle has a sheathed portion at a first end and an exposed portion at a second end;
securing the sheath to the bundle using an adhesive material; and
forming a needle tip on the second end of the bundle.

8. The method of claim 7, wherein forming the needle tip comprises: placing a rounded bead on the second end.

9. The method of claim 8, wherein the rounded bead is formed from one of a silicon carbide precursor and a polymer material.

10. The method of claim 7, wherein forming the needle tip comprises: sharpening the second end to form a point.

11. The method of claim 10, wherein the second end is sharpened using one of a grinding wheel and a jig.

12. The method of claim 7, and further comprises: attaching each of the plurality of needles to a backplate.

13. A method of forming a needle suitable for perforating a fibrous preform, the method comprising:
arranging a plurality of ceramic filaments in a length-wise manner to form a bundle;
coating the bundle with a reinforcing material;
wrapping a sheath around the bundle such that the bundle has a sheathed portion at a first end and an exposed portion at a second end;
securing the sheath to the bundle using an adhesive material; and
forming a needle tip on the second end of the bundle.

14. The method of claim 13, wherein forming the needle tip comprises: placing a rounded bead on the second end.

15. The method of claim 14, wherein the rounded bead is formed from one of a silicon carbide precursor and a polymer material.

16. The method of claim 13, wherein forming the needle tip comprises: sharpening the second end to form a point.

17. The method of claim 16, wherein the second end is sharpened using one of a grinding wheel and a jig.

18. The method of claim 13, and further comprises: attaching the needle to a backplate.

19. The method of claim 13, wherein the reinforcing coating comprises one of epoxy, a ceramic, a polymer-derived ceramic, and a silicon alloy.

20. The method of claim 13 and further comprising: after forming the needle, applying silicon carbide to the needle using chemical vapor infiltration.
